(19) United States
(12) Patent Application Publication
(10) Pub. No.: US 2003/0221590 A1
(43) Pub. Date: Dec. 4, 2003

(54) Non-toxic corrosion-protection pigments based on permanganates and manganates

(76) Inventors: Jeffrey A. Sturgill, Fairborn, OH (US); Andrew Wells Phelps, Kettering, OH (US)

Correspondence Address: Killworth, Gottman, Hagan & Schaeff, L.L.P., Suite 500, One Dayton Centre, Dayton, OH, 45402-2023, US

(21) Appl. No.: 10/341,556

(22) Filed: Jan. 13, 2003

(51) Int. Cl. C01G 45/12

(52) U.S. Cl. 106/401; 423/599; 427/299; 427/327; 106/427; 106/481; 106/499; 106/455; 106/450; 106/461; 106/14.11; 106/14.12; 106/14.15; 106/14.21; 106/14.41; 106/14.42; 106/14.43; 106/14.44

(57) ABSTRACT

Corrosion-inhibiting pigments based on manganese are described that contain a heptavalent (permanganate), hexavalent (manganate), or pentavalent (manganate) compound. An inorganic or organic material is used with the heptavalent, hexavalent, or pentavalent manganese ion to form a compound that is sparingly soluble in water. Specific solubility control cations are chosen to control the release rate of heptavalent, hexavalent, or pentavalent manganese during exposure to water and to tailor the compatibility of the powder when used as a pigment in a chosen binder system. Solubility control agents may also modify the processing and handling characteristics of the formed powders. Many permanganate or manganate compounds are presented that can equal the performance of conventional hexavalent chromium systems. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 C.F.R. §1.72(b).

### CROSS-REFERENCE TO RELATED APPLICATIONS

This application is related to commonly assigned U.S. patent application Ser. No. ______(Attorney Docket No. UVD 0319 PA) NON-TOXIC CORROSION-PROTECTION PIGMENTS BASED ON MANGANESE, filed Jan. 13, 2003 by Sturgill et al., the disclosure of which is incorporated herein by reference.

### BACKGROUND OF THE INVENTION

This invention relates generally to compositions and methods for the formation of protective, corrosion-inhibiting pigments without the use of chromium in the hexavalent oxidation state. More particularly, this invention relates to non-toxic, corrosion-inhibiting pigments based on pentavalent, hexavalent, and heptavalent manganese and methods of making and using the same.

Inhibiting the initiation, growth, and extent of corrosion is a significant part of component and systems design for the successful long-term use of metal objects. Uniform physical performance and safety margins of a part, a component, or an entire system can be compromised by corrosion. Aluminum, zinc, iron, magnesium, titanium and their alloys tend to corrode rapidly in the presence of water due to their low oxidation-reduction (redox) potentials. The high strength 2000 and 7000 series of aluminum alloys are used extensively in aircraft and are very sensitive to corrosive attack. Materials such as steels and carbon fibers with higher redox potentials will form a galvanic couple in water and promote corrosive attack when located near light metal alloys such as aluminum.

A bare metal surface or one that has been conversion coated, phosphated, sealed, rinsed, or otherwise treated will be protected by the application of a primer paint with a corrosion inhibiting pigment. As used herein, the term “pigment” means chemically active compounds with the ability to inhibit corrosion at a distance, rather than simple colorants or opacifiers. Oxidative compounds that are effective as corrosion inhibitors tend to be highly colored and/or opaque. An effective corrosion inhibiting pigment has throwing power and can protect exposed base metal in a scratch or flaw by oxidizing and passivating it at a distance during aqueous corrosion when dispersed in a suitable carrier phase. These compounds are usually solids or liquids that are typically dispersed in a liquid carrier or binder system such as a paint or wash. These compounds may also be used to help inhibit corrosion without a significant liquid carrier using an integral binder and/or a low-volatile application method. Barrier layer formers such as sol-gel coatings or polymeric films are also used, but they tend to have no inherent oxidizing character and no appreciable throwing power and fail to protect the metal surface when the film is breached.

Pigments that contain hexavalent chromium (CrVI) compounds are the de facto standard for high-performance corrosion inhibiting paints and coatings for metal protection and are a typical corrosion inhibitor used to protect aluminum, zinc, magnesium, iron, titanium, copper and their alloys. Zinc (C.I. Pigment Yellow 36) and strontium (C.I. Pigment Yellow 32) chromate pigments are typically used, although calcium and magnesium chromates have also seen some limited use as pigments. The coating vehicles of these pigments include alkyd-type primers, acrylic primers, and elastomeric sealants, among others. Some transition metal chromate pigments (e.g., complexed with copper, iron, manganese, or cobalt) and organic chromate pigments (e.g., bound with nitrogenous compounds such as guanidinium) have been used in protective coatings systems. Barium or lead chromates have been used more as colorants than as corrosion inhibitors. Variations in chromate speciation (i.e., what the chromate ions are bound to) will result in significant differences in protection when used as corrosion-inhibiting pigments.

A clear correlation between performance and solubility of chromate pigments has been shown. However, oxidizing chromates can be dangerous to use as corrosion inhibitors if they are not delivered in sufficient quantity and in a timely manner to the location of a coating breach. The chromate composition was far more important to the corrosion inhibiting performance of the primer film than the organic coating composition.

A principle use of zinc and strontium chromate pigments is in wash- or etch-primer formulations for aluminum protection. Wash- or etch-primers, which have been used since the 1940s, represent one of the harshest application conditions for chromate pigments. Wash-primers are applied to metal surfaces under acidic conditions where the primer is cured as a corrosion inhibiting film. Chromate pigment powders dispersed in an alcohol/resin base mixture are combined with an aqueous phosphoric acid diluent solution. The acid roughens the metal surface and initiates cross-linking of the resin to form a pigment-filled polymeric film. The chromate pigment may also be dispersed in other carriers that are not as harsh as the wash primer. However, if a corrosion-inhibiting pigment can survive the harsh conditions of acid diluent, then it can usually be successfully incorporated within other paint, polymeric, or barrier film systems for corrosion inhibition.

An important use of chromate pigments is in coil coating formulations for steel, zinc-coated steel, or aluminum sheet stock. Coil coating can represent a challenging application environment for pigments in that cure temperatures for these paints can exceed 100° C. Corrosion-inhibiting pigments for these applications must exhibit both throwing power to inhibit corrosion and be thermally stable at elevated temperatures when incorporated into the paint.

Significant efforts have been made in government and industry to replace CrVI with other metals for corrosion-inhibiting applications due to toxicity, environmental, and regulatory considerations. An effective replacement for hexavalent chromate pigment needs to have throwing power for self-healing coating breeches. “Throwing power” is the ability of a highly oxidized compound, such as hexavalent chromium, to oxidize and passivate the exposed bare metal in a small scratch or flaw.

A number of materials have been introduced as corrosion-inhibiting replacement pigments for hexavalent chromium-based compounds. Commercially available corrosion inhibiting pigments including compounds such as molybdates, phosphates, silicates, cyanamides, and borates, which have no inherent oxidizing character, have been used as alternatives to chromate pigments. Coatings that contain these materials can effectively inhibit corrosion as barrier films until the coating is breached, as by a scratch or other flaw. Films or coatings that do not contain oxidizing species can actually enhance corrosion on a surface after failure due to the effects of crevice corrosion.

Manganese is one non-toxic, non-regulated metal which has been considered as a chromium replacement. Manganese (like chromium) exhibits more than one oxidation state [Mn⁺², Mn⁺³, Mn⁺⁴, Mn⁵ (manganates), Mn⁺⁶ (manganates), and Mn⁺⁷ (permanganates)]. In addition, the oxidation-reduction potential is comparable to that of CrVI in acidic solutions. For example, in acid solution:

MnO₄⁻(MnVII—permanganate)+8H⁺+5e⁻ [symbol] Mn⁺²+4H₂O+1.51 V

MnO₄²⁻(MnVI—manganate)+8H⁺+4e⁻ [symbol] Mn⁺²+4H₂O+1.74 V

Cr₂O₇²⁻(Cr⁺⁶—dichromate)+14H⁺+6e⁻ [symbol] 2Cr⁺³+7H₂O+1.36 V

Although the MnVII ion is a very good oxidizing species with an oxidation-reduction potential of +1.51 V (at pH 0), the MnVI ion is an even better oxidizer having a redox potential of +1.74 V (at pH 0). The hydroxyl and oxygen liberated from water when MnVII or MnVI is reduced will oxidize nearby bare metal. This results in a passivated metal surface if sufficient oxygen is released. The potential required to reduce heptavalent manganese to divalent manganese is only 0.15 volts greater than that needed to add three electrons to reduce CrVI to trivalent chromium (CrIII). The oxidation-reduction potential of the MnV species has never been experimentally determined, but it is also a good oxidizing species. MnII is formed during corrosion inhibition by the oxidation of base metal in the presence of MnVII or MnVI and water. MnII is similar to CrIII in that neither is particularly effective as redox-based corrosion inhibitors.

German Patent No. DE 41 31 548 A1 and U.S. Pat. No. 5,254,162 to Speer, et al. describe the formation of manganese-containing pigments using permanganate precursors (along with other Mn sources) and firing to temperatures in excess of 1200° C. These pigments and frits are described as being colorants for ceramics—not as corrosion inhibitors. In addition, a review of the thermal stability of permanganates indicates that at the conclusion of this thermal treatment no permanganate can possibly remain. For example, potassium permanganate begins to decompose at approximately 240° C. The manganese contained in the formed pigments of the Speer et al. products thermodynamically must exist in a lower oxidation state such as MnII, MnIII, or MnIV. The manganese in the pigments described in the present application do not exist in the MnVII or MnVI oxidation states.

Indian Patent No. 146,810 to Rathi describes a barium manganate-containing pigment. However, this pigment is described as being a colorant and not as an active corrosion-inhibiting compound.

To date, no truly effective replacements haven been developed for pigments based on CrVI. Accordingly, the need remains for improved corrosion-protective pigments composed of currently unregulated and/or nontoxic materials that have an effectiveness, ease of application, and performance comparable to current CrVI pigment formulations, and for methods of making and using the same.

### SUMMARY OF THE INVENTION

This need is met by the present invention which represents a significant improvement in the formulation of non-toxic pigments through the use of pentavalent manganese (manganates or hypomanganates), hexavalent manganese (manganates), and heptavalent manganese (permanganates). Although the present invention is not limited to specific advantages or functionality, it is noted that the manganate and/or permanganate pigments of the present invention have been demonstrated with accelerated corrosion testing to retard corrosion to a higher degree than prior art manganese pigments and other alternatives to CrVI-based corrosion inhibiting pigments. These pigments have been tested to inhibit corrosion to the same degree as zinc and strontium chromate-based CrVI pigments. The raw materials are not exotic, are relatively inexpensive, and do not require complicated synthesis methods.

The present invention utilizes stabilization of the pentavalent, hexavalent, or heptavalent manganese ions in the as-formed pigments to achieve corrosion resistance comparable to chromate-based CrVI pigments. More specifically, in order to achieve a high degree of corrosion resistance, a MnVII-based or MnVI-based pigment must exhibit the following characteristics:

1) A corrosion inhibiting pigment must contain a suitable source of oxidizing species. These species quickly oxidize bare metal and form a protective surface if bare metal is exposed in a coating breach.

2) The MnV, MnVII, or MnVI pigment powder must be a “sparingly soluble” compound in water when dispersed in its binder-carrier system. If the pigment is too insoluble in the selected coating system, an insufficient amount of corrosion inhibitor will be delivered to a flaw. A poorly formed, incomplete oxide layer produced by a pigment of too low solubility will not only fail to inhibit corrosion, but can promote crevice corrosion and result in locally enhanced corrosion rates.

The reservoir of oxidizing ions can be quickly flushed away if the pigment is too soluble, and typical corrosion will begin. Highly soluble pigments are also known to result in osmotic blistering of paint films and coatings. Permanganate or manganate pigments that are too soluble can also be responsible for osmotic blistering depending on the aqueous permeability of the carrier film.

It is difficult to place specific solubility values to these optimum “sparingly soluble” pigment materials because there appear to be several variables associated with what makes an optimum anticorrosive pigment material (e.g., resin/binder system in which it is placed). It appears that if the permanganate or manganate pigment exhibits a solubility in water of between about 1×10⁻⁴ and about 1×10⁻¹ moles per liter of pentavalent, heptavalent, or hexavalent manganese, then appreciable corrosion inhibition will be observed. Pigments that incorporate permanganate or manganate compounds that fall outside of this particular range may also exhibit some corrosion inhibition. For example, pigments with solubilities as high as 1×10⁰ moles per liter or as low as 1×10⁻⁵ moles per liter of pentavalent, heptavalent, or hexavalent manganese at standard temperature and pressure (about 25° C. and about 760 Torr) will exhibit some corrosion resistance in certain binder systems, although not as great as those compounds which fall within the optimum solubility range. The degree of effectiveness will depend on the particular compound itself. The solubility characteristics of the permanganate or manganate in the pigment must be controlled through the use of solubility control cations that form compounds that fall within a desired solubility range. In this way, a “controlled release” of permanganate or manganate can be achieved, much like the “timed release” of hexavalent chromium is achieved in the “state-of-the-art” systems.

3) The permanganate or manganate pigment compound optionally establishes an electrostatic barrier layer around the cation-(per)manganate compound in aqueous solutions. The nature and character of the electrostatic double-layer surrounding the cation-(per)manganate compound may be controlled and modified by careful selection of cation species. In general, the electrostatic double layer formed acts to protect the MnV, MnVII, or MnVI from premature reaction with hydronium, hydroxide, and other ions in solution. The formation of electrostatic barrier layers also helps to impede the passage of corrosive ions through the binder phase to the metallic surface.

4) The permanganate or manganate pigment compound can optionally exhibit a color change between the pentavalent, heptavalent, or hexavalent and divalent manganese oxidation states. This color change can act as a metric to determine when the “throwing power” associated with the pigments is no longer available, and when the paint system in which it is contained needs to be replaced. For this reason, it is also optionally important that the color of these pigments that exhibit a color change between oxidation states is light-fast (i.e., not changed by strong light).

The effectiveness of an oxidizing species is a function of its individual oxidation-reduction potential, and more highly oxidized species exhibit greater corrosion protection, although lower stability. A solubility control cation is necessary to provide a timed release of the inhibitor ion. Thus, a solubility control cation is required for the permanganate or manganate ions because of their reactivity and to produce controlled solubilities. The corrosion resistance of a number of aluminum alloys as tested using both ASTM B-117 and ASTM G-85 has been enhanced through the use of stabilized permanganate and manganate pigments. Not only do these optimized pigments retard corrosion to a higher degree than other prior art pigments, but their corrosion resistance is comparable to that of hexavalent chromium systems.

In one aspect, the invention comprises a mechanistic and chemical approach to the production of corrosion-inhibiting pigments using permanganates or manganates. This approach uses solubility control cations which form compounds with permanganates or manganates that are sparingly soluble in aqueous solution, typically in a range of approximately 1×10⁻¹ to 1×10⁻⁴ moles/liter of pentavalent, hepavalent, or hexavalent manganese. This solubility range provides a release of permanganate or manganate at a rate slow enough that most binder systems will provide protection for an extended period of time and fast enough to inhibit corrosion during conventional accelerated corrosion testing methods such as ASTM B-117 and G-85. Compounds that fall slightly outside of this solubility range (as high as 1×10⁰ to as low as 5×10⁻⁵ moles/liter of pentavalent, heptavalent, or hexavalent manganese) may also provide some corrosion-inhibiting activity under certain conditions and binder systems. However, pigment compounds with aqueous solubilities far outside of the target range are likely to be inefficient corrosion inhibitors. Solubility control can be achieved using organic or inorganic cationic materials.

In an optional aspect, the invention is the achievement of corrosion-resistant pigments using heptavalent or hexavalent manganese by the use of cationic materials which form compounds with the permanganate or manganate that exhibit electrostatic dipoles to form electrostatic barrier layers composed of ions such as hydronium (H₃O⁺) or hydroxide (OH⁻) in the presence of water. The formation of these electrostatic barrier layers can be achieved using organic or inorganic cations.

In another optional aspect, the decomposition temperature of the permanganate or manganate compound upon which the pigment is based should be above 100° C. In addition, the melting temperature of the complex is typically above 50° C., although lower-melting complexes may have some applications.

In another optional aspect, the permanganate or manganate pigment compound upon which the pigment is based should exhibit a color change between the pentavalent, heptavalent, or hexavalent and divalent oxidation states. This allows for a visual metric of when the pigment has lost its throwing power, and the binder system within which it is contained must be replaced. Therefore, it is desirable that the color of these pigments be light-fast (unchanged by exposure to strong light).

These MnV, MnVII, and MnVI compounds represent a substantial performance improvement over prior art related to pigment alternatives (including those based on manganese) used to replace CrVI-based corrosion inhibiting pigments. They also provide a capability to tailor the corrosion inhibiting pigment to the carrier system. This allows current binder/resin systems used for chromates to be used for MnVII, MnVI, and/or MnV based systems without modification. Likewise, new binder/carrier/resin systems with improved physical properties can be developed without the restriction of compatibility with zinc or strontium chromate.

The raw materials needed for the solutions used to form these coatings are relatively inexpensive. The pigments do not use exotic materials or require complicated synthesis methods.

Accordingly, it is an object of the present invention to provide non-toxic, corrosion-protective pigments based on permanganates or manganates and for methods of making and using the same. These and other objects and advantages of the present invention will be more fully understood from the following detailed description of the invention. It is noted that the scope of the claims is defined by the recitations therein and not by the specific discussion of features and advantages set forth in the present description.

### DETAILED DESCRIPTION OF THE INVENTION

A. Starting Materials

Three general starting materials are used for the preparation of heptavalent, hexavalent, or pentavalent manganese corrosion-inhibiting pigments. These include a manganese source, an oxidation source (if the precursor is a divalent, trivalent, or tetravalent manganese salt), and a solubility control cation.

1) Manganese Source

a) Heptavalent Manganese (Permanganates)

Manganese is a nontoxic, non-regulated replacement metal for chromium that exhibits more than one oxidation state (MnII, MnIII, MnIV, MnV, MnVI, and MnVII). The oxidation reduction potentials for MnVII-MnII and MnVI-MnII are comparable to that of the CrVI-CrIII couple. Important characteristics of the MnVII, MnVI, and MnV ions which are relevant to their use in pigment applications include: (1) their compounds typically have large aqueous solubilities; (2) manganate compounds are more stable in basic pH solutions than in acidic or neutral solutions; and (3) the ionic radius of 46 pm for MnVII is comparable to the CrVI ion (44 pm), and it will therefore have a comparable charge density (electrostatic field) per ion. However, the ionic radius for MnVI is 25.5 pm, meaning it will have a correspondingly higher charge density (electrostatic field) if compared to CrVII. Forming a compound with the aqueous solubility required of a corrosion inhibiting pigment is problematic for MnVII, MnVI, and MnV because of the need to retain its oxidation state on drying and later during exposure to the corrosive environment.

Permanganates and permanganate pigments are noted for their unique purple or reddish-purple coloration. Coincidentally, the most favorable manganese source for permanganate pigments is a compound with the manganese already in the heptavalent oxidation state (permanganates). Heptavalent manganese precursors include, but are not limited to: potassium permanganate, sodium permanganate, lithium permanganate, ammonium permanganate, magnesium permanganate, calcium permanganate, strontium permanganate, barium permanganate, zinc permanganate, ferric permanganate, nickel permanganate, copper permanganate, cobalt permanganate, cerium permanganate, lanthanum permanganate, yttrium permanganate, and aluminum permanganate.

The manganese source for permanganates may also be a compound with manganese in the hexavalent or pentavalent oxidation states. Hexavalent or pentavalent manganese precursors for permanganates include, but are not limited to, potassium manganate and sodium manganate. These hexavalent or pentavalent manganese sources are then oxidized to the heptavalent oxidation state using a strong oxidizer or electrolytic oxidation (see section 2 below). Oxidation of manganates to permanganates using electrolytic oxidation is the current synthetic route to useful compounds such as potassium permanganate. Thus, the preparative conditions are well established. Chemical oxidizers under mildly acidic conditions will also successfully oxidize hexavalent or pentavalent manganese to heptavalent manganese.

The manganese source for permanganates may also be a compound with manganese in the tetravalent (MnIV) or trivalent (MnIII) oxidation states. For example, manganese dioxide (Mn^{IV}O₂) is commonly oxidized to MnVI using oxygen in an alkaline medium. Further oxidation to permanganate using elemental chlorine (acidic) is then readily accomplished. Trivalent manganese or tetravalent manganese compounds suitable as precursors for permanganates include manganese dioxide (MnO₂), manganomanganic oxide (Mn₃O₄), manganese sesquioxide (Mn₂O₃), lithiated manganese spinel (LiMn₂O₄), calcium manganese spinel (CaMn₂O₄), zinc manganese spinel (ZnMn₂O₄), potassium or sodium manganese oxide (KMn₈O₁₆), barium manganese oxide (Ba,H₂O)₂Mn₅O₁₀, and manganese III hydroxide (MnOOH).

Permanganate precursors can also be nearly any water, alcohol, or hydrocarbon soluble manganese compound in which the manganese has the divalent oxidation state. Water-soluble precursors are typically used. Inorganic divalent manganese precursor compounds include, but are not limited to: manganese nitrate, manganese sulfate, manganese perchlorate, manganese chloride, manganese fluoride, manganese bromide, manganese iodide, manganese bromate, manganese chlorate, and complex fluorides such as manganese fluosilicate, manganese fluotitanate, manganese fluozirconate, manganese fluoborate, and manganese fluoaluminate. Organometallic divalent manganese precursor compounds include, but are not limited to: manganese formate, manganese acetate, manganese propionate, manganese butyrate, manganese valerate, manganese benzoate, manganese glycolate, manganese lactate, manganese tartronate, manganese malate, manganese tartrate, manganese citrate, manganese benzenesulfonate, manganese thiocyanate, and manganese acetylacetonate.

MnVII is capable of providing corrosion protection at a distance to a metal surface in the presence of coating flaws such as scrapes, scratches, and holes because of its throwing power. The solubility of the MnVII compound needs to be tailored to suit the needs of the protection system and must be neither too high, nor too low in that system. The protective system includes the binder phase, assorted modifiers, and under- and over-coatings. The system needs to be performance matched to its intended usage environment. Timely release and throwing power of the inhibitor are basic to protective performance, but controlled tailoring of these has not been taught in the prior art. Likewise, the body of systematic chemistry data required to control these properties has not been readily available in a form useful to help design coatings. The present invention outlines how to control the solubility of MnVII with a variety of materials so the MnVII may be adapted to a multitude of pigment applications with specific compatibility requirements.

b) Hexavalent Manganese (Manganates)

The hexavalent manganese ion (MnVI) is an even better oxidizing species than MnVII. It has a radius of only 25.5 pm (MnVI is 4-coordinate, as opposed to the 6-coordinate MnVII ion). However, MnVI has a correspondingly lower stability both in and out of solution compared to MnVII. MnVI is generally stable only in alkaline conditions. These parameters make the widespread application of manganates (MnVI) problematic, but it is suitable as a pigment material under certain conditions. Hexavalent manganates and hexavalent manganate pigments are noted for their unique dark green coloration.

Hexavalent manganates are readily prepared by the reduction of permanganates in alkaline conditions. Therefore, a suitable manganese source for hexavalent manganate pigments is water-soluble or water-insoluble permanganates. Heptavalent manganese precursors include, but are not limited to: potassium permanganate, sodium permanganate, lithium permanganate, ammonium permanganate, magnesium permanganate, calcium permanganate, strontium permanganate, barium permanganate, zinc permanganate, ferric permanganate, nickel permanganate, copper permanganate, cobalt permanganate, cerium permanganate, lanthanum permanganate, yttrium permanganate, aluminum permanganate, cesium permanganate, rubidium permanganate, and bismuth permanganate.

Hexavalent manganate pigments can also be precipitated from an aqueous solution of a water-soluble manganate. Hexavalent manganese precursors include, but are not limited to, potassium manganate and sodium manganate.

Hexavalent manganates are also readily formed by the oxidation of tetravalent or trivalent manganese under alkaline conditions. For example, manganese dioxide (Mn^{IV}O₂) is commonly oxidized to MnVI using oxygen in an alkaline medium. Trivalent manganese or tetravalent manganese compounds suitable as precursors for manganates include manganese dioxide (MnO₂), manganomanganic oxide (Mn₃O₄), manganese sesquioxide (Mn₂O₃), lithiated manganese spinel (LiMn₂O₄), calcium manganese spinel (CaMn₂O₄), zinc manganese spinel (ZnMn₂O₄), potassium or sodium manganese oxide (KMn₈O₁₆), barium manganese oxide (Ba,H₂O)₂Mn₅O₁₀, and manganese III hydroxide (MnOOH). Trivalent or tetravalent manganese also occurs in such natural minerals as pyrolusite, hausmannite, manganite, ramsdellite, bixbyite, groutite, feitknechite, akhtenskite, buserite, nsutite, hetaerolite, marokite, hydrohetaerolite, braunite, psilomelane, romanechite, cryptomelane, manjiroite, hollandite, and birnesite.

Lastly, hexavalent manganese can be formed by the strong oxidation of divalent manganese under alkaline conditions. Therefore, the water-soluble divalent manganese sources listed under permanganate sources above are acceptable precursors. Alkaline dissolution of normally water-insoluble divalent manganese sources with concurrent oxidation is also acceptable. Examples of water-insoluble divalent manganese compounds suitable for manganates include manganese oxide (manganosite), manganese hydroxide (pyrochroite), manganese carbonate (rhodochrosite), manganese silicate (rhodonite, tephroite, manganhumite, or manganjustite), manganese sulfide (alabandite or hauerite), manganese phosphate (reddingite or hureaulite), manganese oxalate, and manganese borate.

c) Pentavalent Manganese (Manganates or Hypomanganates)

Pentavalent manganese is the rarest of the higher oxidation states of manganese. Like hexavalent manganese, pentavalent manganese is stable only in alkaline conditions. It is suitable as a pigment material under certain conditions. Pentavalent manganates and pentavalent manganese pigments are noted for their blue coloration.

Pentavalent manganese exhibits a range of anionic compositions. The most common is MnO₄³⁻, although [(MnO₄)₃OH]¹⁰⁻ and [MnO₄OH]⁴⁻ have been observed. Anionic species that incorporate halides, such as [(MnO₄)₃X]¹⁰, where X=F or Cl, have also been formed containing pentavalent manganese.

Pentavalent manganates are prepared in a similar fashion to hexavalent manganates. Therefore, controlled reduction of permanganates is a typical option. Precipitation from water-soluble manganates is another option. Lastly, oxidation of tetravalent, trivalent, or divalent manganese under alkaline conditions is still another option.

2) Oxidation Source

An oxidizing species will typically be included in the synthesis solution if lower oxidation state manganese compounds are used as precursors for MnV, MnVI, or MnVII. Otherwise, a post-precipitation oxidation step will be required. Additional amounts of oxidizer may be added to help control and maintain a desired amount of MnV, MnVI, or MnVII in the pigment solution by reoxidizing MnV, MnVI, or MnVII that has become reduced. Strong oxidizers are required because of the high potential of their redox reaction. The oxidizers may be gases, liquids, or solids. Solid oxidizers are typically used for this application due to ease of handling and reagent measurement. Other starting materials (manganese source and solubility control cation source) will also frequently be solids. Liquid oxidizers may be used, but handling and accurate process metering have proven difficult. Gaseous oxidizers may be the most cost effective and chemically efficient on a large scale, but are also the most problematic due to handling and venting concerns.

Oxidizers suited for the purpose of producing and maintaining the manganese ion in the heptavalent, hexavalent, or pentavalent charge state include, but are not restricted to: peroxides and peroxo compounds (including superoxides, persulfates, perborates, pernitrates, perphosphates, percarbonates, persilicates, peraluminates, pertitanates, perzirconates, permolybdates, pertungstates, pervanadates, and organic peroxyacid derivatives), ozone, hypochlorites, chlorates, perchlorates, hypobromites, chlorites, bromates, bismuthates, periodates, and dissolved gases such as oxygen, fluorine, or chlorine. Inorganic and organic derivatives of these compounds may be used. Typical oxidizers for this use are peroxides, persulfates, perbenzoates, periodates, bismuthates, hypochlorites, gaseous dissolved oxygen, and even the oxygen content of air. In general, any inorganic, organic, or combination species with an oxidation potential of +1.4V or greater (at a pH of 1) will be capable of oxidizing manganese to the heptavalent, hexavalent, or pentavalent oxidation state.

Oxidized manganese may also be produced in solution by electrolytic oxidation. However, this approach may not be economically feasible due to the energy costs associated with electrolytic oxidation.

It is also possible to produce a divalent, trivalent, or tetravalent manganese compound, and then apply an oxidizer to oxidize to pentavalent, hexavalent, or heptavalent manganese. This, however, is less typical because the percentage of pentavalent, hexavalent, or heptavalent manganese will decrease from the outside to the interior of the pigment particle.

3) Solubility Control Cation

Manganese is effective as an oxidative corrosion inhibitor if it can be supplied in sufficient quantities in the pentavalent, hexavalent, or heptavalent charge-state when brought into contact with unprotected bare metal. Corrosion resistance comparable to that of CrVI can be achieved by the use of MnV, MnVI, or MnVII oxidizer ions in pigment compounds. The exact solubility of this compound may be modified by species released into solution by the dissolving metal surface or by the subsequent addition of solubility control agents. A variety of inorganic and organic stabilizers are available that can serve to control solubility.

The key to providing a useful source of pentavalent, hexavalent, or heptavalent manganese at a metal surface is the creation of a sparingly soluble compound in which the MnV, MnVI, or MnVII ion is shielded from premature reduction during and after pigment formation. The formation of pigments with the proper release rate of MnV, MnVII, or MnVI ions is problematic because of the high solubility of these ions, especially MnVII. A solubility control cation is necessary to form a sparingly soluble compound in order to produce the active corrosion-inhibiting component in a pigment. It is difficult to place specific solubility values to these optimum sparingly soluble pigments because of the wide range of binder systems in which corrosion-inhibiting pigments are used.

A permanganate or manganate compound with a solubility in water of between about 1×10⁻⁴ and about 1×10⁻¹ moles per liter of heptavalent, hexavalent, or pentavalent manganese should exhibit appreciable corrosion inhibition when used as a primer pigment. This solubility range provides a release of MnVII, MnVI, or MnV at a rate slow enough that protection will be provided for an extended period of time and fast enough to inhibit corrosion during conventional accelerated corrosion testing methods such as ASTM B-117 and G-85 for coatings that contain these pigments. Permanganate or manganate compounds that fall outside of this particular solubility range may exhibit a small degree of corrosion inhibition. For example, compositions with solubilities as high as 1×100 moles per liter or as low as 5×10⁻⁵ moles per liter of pentavalent, hexavalent, or heptavalent manganese will exhibit some corrosion resistance, although they will not be as effective as those compounds within the optimum solubility range. The more common permangante compounds, such as the potassium or sodium salts are generally too soluble to provide effective corrosion inhibition if incorporated into a binder system such as a paint.

The needed solubility will be strongly dependent on the net aqueous solubility of overlying paints and coatings and their usage environment. For example, solubility tailoring would be useful in a situation where a protected substrate is suddenly immersed in seawater, or where a rubber sealant allows only limited water penetration. Adequate corrosion protection could be achieved through the formation of a permanganate or manganate pigment compound that exhibits a higher solubility in water (e.g., 1×10⁰ to 1×10⁻³ moles per liter MnV, MnVI, or MnVII). A rapid release of protective MnV, MnVI, or MnVII ions would happen at the expense of depleting the manganese quickly from the coating. Permanganate or manganate pigments of lower solubilities (e.g., 5×10⁻⁵ to 1×10⁻³ moles per liter MnV, MnVI, or MnVII) may also be useful in some situations (e.g., as paints in nearly pure deoxygenated water). The number and range of compound solubilities offered by permanganate or manganate compounds allows the development of protective coating systems with broad performance and application ranges. This feature is not presently available even for CrVI based corrosion inhibiting pigments.

Several variables are associated with making optimized pigments. If the pigment is too insoluble, then insufficient permanganate or manganate is available to inhibit corrosion. Low solubility compounds that do not provide a sufficient amount of oxidation quickly enough to a coating breach may produce an incomplete oxide layer and thus an ineffective barrier film. If the permanganate or manganate pigment is too soluble, it will be washed away quickly, and an incomplete thin oxide film will form that will not provide long-term corrosion protection, or osmotic blistering of the paint system may result. The formation of spotty or patchy oxides can promote localized crevice corrosion and can result in enhanced corrosion rates at the breach.

The traditional chromate pigments are used not only in alkyd resin systems (e.g., DoD-P-15328D Wash Primers), but also in acrylic systems (e.g., MIL-P-28577B Water-Borne Acrylic Primers), and even in sulfonated rubber sealants (e.g., MIL-PRF-81733D Sealing and Coating Compound). Fortunately, it is possible to tailor the permanganate or manganate compound pigment systems themselves to specific binder/solvent systems using solubility (cohesion) parameters. Solubility parameters define how well an inorganic or organometallic complex will disperse in a given resin/binder system. This represents a radical departure from traditional paint systems, in which the paint systems are configured to specific pigments.

The formation of an electrostatic double layer can be important for the effectiveness of a corrosion inhibitor once it is released into solution during corrosion. There are differences in anodic and cathodic polarization, solubility, and the saturated pH of aqueous solutions of various chromate pigments. The formation of an electrostatic double layer around the pigment while in its carrier film will not be as important as when the species is in solution. For this reason, the development of an electrostatic double layer around the pigment is an optional consideration. For example, zinc chromate pigment-filled paint does not exhibit electrochemical inhibiting behavior. The carrier film typically behaves as a water impermeable barrier and will muffle the polar character of the pigment. The hexavalent chromium pigments SrCrO₄ and ZnCrO₄ have very small barrier layers associated with them, but they are effective as corrosion-inhibiting pigments. Optimized solubility for permanganate or manganate compounds alone can result in corrosion resistance comparable to the state-of-the-art chromium pigments. The degree of polarization exhibited by the MnVI ion will be greater than the CrVI ion because of its smaller ionic radius and higher charge-state, and it will be more efficient in forming electrostatic double layers in aqueous solution, whereas the MnVII ion will exhibit comparable electrostatic double layers in aqueous solution due to comparable ionic size.

The melting point and decomposition temperature of the pigment material are also important, and can be modified through the selection of different solubility control cations. Permanganate or manganate compounds that decompose below about 100° C. limit both their useful lifetimes and range of use. The melting temperature should be above about 50° C. to ensure that the liquid phase does not form during normal handling procedures. An additive may be needed for pigments with melting temperatures below about 50° C. Inert solid addendum materials need not have any inherent corrosion-inhibiting capability and are used to provide a base (support) that the pigment can absorb on or into. Oxides, phosphates, borates, silicates, and polymers are examples of support compounds that can be used. Low melting temperature pigments (below about 50° C.) can be used, but they require handling and processing different from higher melting temperature pigments.

The permanganate (Mn^{VII}O₄₋), manganate (Mn^{VI}O₄²⁻), and (hypo)manganate (i.e., Mn^{V}O₄³⁻) ions require cations to complete the charge balance for the formation of pigment compounds. Due to differences in the solubility, coordination number, and ionic characteristics of these anions, it is best to treat each separately when discussing the solubility control cations that function best for the formation of “sparingly soluble” pigment compounds.

a) Solubility Control Cations for Permanganate Pigments

Only monovalent or lanthanide cations are suitable for forming permanganate pigments of the desired solubility characteristics. Divalent (i.e., Mg⁺², Ca⁺², Sr⁺², Zn⁺², and even Ba⁺²) cations exhibit much higher solubilities in water than is desired in a corrosion-inhibiting pigment. Moreover, many monovalent cations (such as, for example, NH₄⁺, Li⁺, Na⁺, and K⁺) also form permanganate compounds that are too soluble for use as pigments.

Optimum solubility control can be achieved through the use of inorganic tri- and monovalent cations which can include: Y⁺³, La⁺³, Ce⁺³, Pr⁺³, Nd⁺³, Cs⁺, Rb⁺, Ag⁺, BiO⁺, and SbO⁺. Combinations of these cations within the pigment compounds can also be used. Moreover, combinations of these monovalent inorganic cations with K⁺ or Li⁺ can be used for additional solubility control (e.g., increasing the solubility of a given permanganate pigment compound). Any water-soluble precursor compound containing these cations can be used for pigment synthesis.

Cationic solubility control may also be achieved through the use of monovalent organic cations that include, but are not limited to: quaternary ammonium compounds (NR₄⁺, where R can be any combination of alkyl, aromatic, or acyclic organic substituents, such as the methyltriethylammonium ion); organic compounds containing at least one N⁺ site (such as pyridinium or thiazolium cations); organic compounds containing at least one phosphonium site (P⁺, such as the benzyltriphenylphosphonium ion); organic compounds containing at least one stibonium site (Sb⁺, such as the tetraphenylstibonium ion); organic compounds containing at least one oxonium site (O⁺, such as pyrylium cations); organic compounds containing at least one sulfonium site (S⁺, such as the triphenylsulfonium ion); organic compounds containing at least one iodonium site (I⁺, such as the diphenyliodonium ion); or combinations thereof.

The quaternary ammonium compounds, organic compounds containing at least one N⁺ site, and organic compounds containing at least one oxonium site are the most important of these classifications because of the very large number of stable cations that are available. Water-soluble precursors for these organic cations are desirable in order to maximize the amount of material available in the appropriate pigment synthesis solution. Most of these materials are also soluble in organic solvents and hydrocarbons. Fluorides, chlorides, and bromides offer the most water-soluble precursors for these organic cations, although nitrates and perchlorates of those cations with lower molecular weights (e.g., tetramethylammonium) are also acceptable water-soluble precursors. Nitrates and perchlorates of larger (greater molecular weight) organic cations are generally not acceptable as precursors because of their low water solubility.

Toxic inorganic or organic monovalent cations can be used as additional solubility control agents although this is less desirable. Examples of toxic monovalent inorganic cations that can be used include, but are not limited to, Tl⁺ and Hg⁺. Examples of toxic organic monovalent cations include, but are not limited to, organic compounds containing at least one arsonium site (an example being the tetraphenylarsonium ion of As⁺), and organic compounds containing at least one selenonium site (an example being the triphenylselenonium ion of Se⁺). Use of these materials for additional solubility control may be necessary in some specific instances where the toxicity of the resulting pigment is of limited importance to the operator. Water-soluble precursors for these toxic cations are typical in order to maximize the amount of available cation for solubility control in aqueous-based synthesis solutions. The organic cations are frequently hydrocarbon-soluble. In general, the nitrates, chlorides, bromides, and perchlorates of these cations offer the highest water solubility.

Carefully selected organic cations are preferable for pigment synthesis due to the ability to increase dispersibility of the permanganate anion in the binder phases of the primer paint. These cations are often more cost effective than the monovalent inorganic cations.

b) Solubility Control Cations for Manganate Pigments

Optimum solubility control for manganates containing either hexavalant or pentavalent manganese can be achieved using a number of inorganic cations. In general, lithium, sodium and potassium manganates are too soluble for use as corrosion-inhibiting pigments, although they are excellent precursor compounds for pigment preparation. Nontoxic inorganic solubility control cations for use with manganates include: Rb⁺, Cs⁺, Ag⁺, Ba⁺², Sr⁺², Ca⁺², Zn⁺², Mg⁺², Co⁺², Bi⁺³, Al⁺³, In⁺³, and combinations thereof. Ba⁺² is particularly useful because of its great ability to insolubilize many sulfur-based corrosion enhancing species such as, for example, elemental sulfur, inorganic sulfides, organic sulfides, H₂S, sulfites, bisulfites, sulfates, SO₃, SO₂, and combinations thereof. The alkali-soluble precursors for these cations are necessary for the pigment synthesis process.

Cationic solubility control for manganates can also be achieved through the use of toxic and/or regulated inorganic cations. Toxic inorganic solubility control cations for use with manganates include: Hg⁺, Cd⁺², Hg⁺², Ni⁺², Pb⁺², Tl⁺³, and combinations thereof.

Organic cations cannot be used with manganates due to the strongly basic conditions necessary for manganate synthesis and stability.

B) Pigment Synthesis

The permanganate and manganate compounds of the present invention can be synthesized by many different formation routes, and the synthesis of specific permanganate or manganate compounds is often found in the general chemistry literature. The syntheses of several MnVII and MnVI compounds suitable for use as pigments are outlined in the Examples section of this specification.

The pigments can be synthesized via precipitation routes (including onto inorganic or organic substrates), by firing of constituents, by evaporative routes, etc. Precipitation is a typical synthesis route, however, because: a) it is easiest to control, and b) many permanganates or manganates are degraded by high temperatures. Precipitation from aqueous (water-based) solutions is typical, because the formed permanganate or manganate pigment materials are required to be sparingly soluble in water in order to function adequately as corrosion-inhibitors. For the more soluble pigments (i.e., with solubilities as high as 1×10⁰ moles/liter of MnV, MnVII, or MnVI, for specialized applications), precipitation can be aided by traditional salting-out methodologies, such as adding salt or alcohols to further facilitate precipitation. If desired, precipitation onto or in combination with inert materials such as oxides, hydroxides, silicates, borates, aluminates, phosphates, carbonates, titanates, molybdates, tungstates, oxalates, polymers, etc., can be initiated.

A typical MnV, MnVII, or MnVI pigment compound was prepared as follows:

1) the permanganate or manganate precursor was dissolved in a minimum of water (manganate precursors in strongly alkaline solutions);

2) the mother liquor was separated into five fractions and an additional solubility control agent was added; and

3) each solution from step 3 was ice chilled and precipitate filtered and dried.

Solubility control cations were used to obtain a broad spectrum of solubilities with a single MnV, MnVII, or MnVI combination. Occasionally a precipitate would not form with the addition of a “solubility control agent” or a day of evaporation. This would imply that the target compound was extremely water soluble and unsuited for use as a pigment. Conversely, a precipitate would occasionally form immediately on addition of the solubility control agent. This would imply that the target MnV, MnVII, or MnVI compound was sparingly soluble and suited for use as a corrosion inhibiting pigment when incorporating the buffer or oxidizer's cations.

Similarly, oxidation or reduction of other manganese compounds to obtain the desired MnVII, MnVI, or MnV pigment compound can also be achieved from aqueous solution. For example, it is possible to reduce barium permanganate to the desired barium manganate simply through dissolution of barium permanganate in a potassium hydroxide solution. Conversely, oxidation of a MnII compound in a barium hydroxide solution was also found to yield the desired barium manganate. In this way, synthesis of desired permanganate or manganate compounds can be tailored to available manganese sources and synthesis reagents.

Once synthesized, the pigments can then be incorporated into a wide range of binder systems to afford corrosion protection. Examples of organic binder systems that can incorporate permanganate or manganate corrosion-inhibiting pigments include, but are not limited to: alkyd-type primers, acrylic primers, polyester primers, epoxy primers, conductive primers, organic sol-gels, ketimine coatings, polyvinyl coatings, acrylic thermoplastics, asphaltic and coal tar thermoplastics, polyamide thermoplastics, polyethylene dispersion thermoplastics, fluorocarbon thermoplastics, chlorocarbon thermoplastics, silicone thermosets, polyurethane thermosets, polyester thermosets, epoxy-amine thermosets, epoxy-amide thermosets, epoxy-ester thermosets, epoxy-coal tar thermosets, furane thermosets, phenolic thermosets, butadiene styrene elastomers, chlorinated rubber elastomers, polysulfonated elastomers, neoprene elastomers, sulfur-containing rubbers, or combinations thereof. Examples of inorganic binder systems that can incorporate permanganate or manganate pigments include, but are not limited to: low temperature enamels, low temperature glass frits, carbonaceous coatings, zeolites, inorganic sol-gels, or combinations thereof.

### Examples

In order that the invention may be more readily understood, reference is made to the following examples, which are intended to illustrate the invention, but not limit the scope thereof.

1) Wash Primer Preparation

The corrosion inhibiting performance of permanganate and manganate pigments was evaluated by incorporating them into primer paint formulations. The acid wash primer paint formulation called out in DoD-P-15328 [Primer (Wash), Pretreatment (Formulation No. 117 for Metals)] was used to test the synthesized pigments. The wash primer is composed of a resin, an acid, a corrosion inhibiting pigment, powdered talc, and carbon lampblack. The acid content of this wash primer provides a rigorous initial test of the stability and performance of the pigments. Other, more benign, polymer-based binder and resin systems might not separate the compounds based on their performance as effectively or as rapidly.

The base solution for the wash primer in this specification was prepared by mixing 88.3 grams of isopropanol, 31.3 grams of n-butanol, and 3.8 grams of deionized water with 14 grams of poly(vinyl butyral) resin (PVB) (Monsanto Butvar B-90™). PVB was used exclusively throughout testing to avoid preparation and compositional complications during analysis of pigment performance. However, the invention is not limited to the use of PVB.

Acid diluent was prepared by mixing 70 grams of 85% phosphoric acid, 63 grams of deionized water, and 247 grams of isopropanol. Finely-ground pigment powder was measured out and added to 13.74 grams of the base solution for each paint to be tested. A small amount (0.2 g) of powdered talc (magnesium silicate) “filler” was added. Lampblack was not added to these samples. These components were mixed thoroughly by hand and 3.8 g of phosphoric acid diluent added with further mixing. This rough processing allowed direct comparisons of pigment performance to be made without complications due to powder treatments, modifications, and additives.

For each pigment to be tested, the primer paint was applied onto 10 metal substrates—5 precleaned 7075-T6 and 5 precleaned 2024-T3 aluminum substrates. This is not the conventional paint application procedure for aluminum alloys. Under normal service conditions, aluminum alloys are first subjected to a hexavalent chromium-containing conversion coating prior to primer application. However, the conversion coating was omitted so that the performance of the pigment alone could be evaluated and not the synergistic effects of hexavalent chromium (in the conversion coating) or even of barrier films (in the phosphate or anodized coatings).

Multiple samples of specific pigment compositions were prepared and tested. Samples treated with zinc and strontium chromate were used as comparison standards. The chromate pigments were prepared identically to those used to test permanganate/manganate composition variations.

2) Corrosion Testing

PVB wash primers containing various pigment formulations were evaluated by exposing them to static salt fog (ASTM B-117) and cyclic Prohesion™ (ASTM G-85.5) accelerated corrosion tests. ASTM B-117 is a traditional corrosion “proof” test that has little relation to a real working environment. This accelerated corrosion test exposes samples to a constant salt-water fog and is a de facto test of solubility for corrosion inhibitors. B-117 does not necessarily test the ability of a corrosion inhibitor to actually inhibit corrosion. This is particularly true of inhibitors and compounds that have not been fully optimized with respect to solubility. ASTM G-85.5 (Prohesion™) is a cyclic corrosion test that more closely resembles real working environments. This accelerated corrosion test exposes samples to a cycle of fog of dilute salt and ammonium sulfate at room temperature followed by forced-air drying at an elevated temperature. This is a more realistic test of the ability of a compound to inhibit corrosion. Results of these tests can be combined to gain insight into how a particular coating or compound will perform relative to a standard as well as helping identify strengths and weaknesses in the performance of the material.

3) Rating Method

ASTM D-1654 evaluation standard for painted or coated specimens subjected to corrosive environments was used to evaluate the performance of the coatings. After the paint dried for 24 hours, each plate was scribed with an X and the plate edges were sealed with PVC tape to eliminate corrosion edge effects.

Two visual observations are associated with this rating test. Procedure A involves a rating of the failure at the scribe—the representative creepage of corrosion away from the scribe. Procedure B involves a rating of the failure in the unscribed areas in terms of the percentage which shows corrosion coming through the film. In this way, not only the bulk corrosion-inhibiting action of a pigment through the binder can be rated, but also its “throwing power”.

4) COMPARISON EXAMPLES

Zinc and strontium chromates are commercial CrVI-based pigments used extensively to provide corrosion protection to metal surfaces. These pigments were used as performance baselines to determine the effectiveness of permanganate-based pigment compositions developed using the methodology described in this specification.

Chromate pigments were precipitated from aqueous solutions and incorporated into PVB wash primer formulations so that each primer sample had the same molar quantity of hexavalent chromium. These primers were then applied to 2024-T3 and 7075-T6 aluminum alloy samples. After the samples had dried for 24 hours, they were scribed and the edges of each sample taped to eliminate edge effects. These samples were then exposed to 168 hours of both ASTM B-117 and G-85.5. Magnesium chromate is so soluble in aqueous solution that the resin began to cross-link immediately, even before the phosphoric acid diluent was added to the PVB pigment mixture. PVB based paints containing magnesium chromate pigments performed well initially (the first 4 days of the test) but began to degrade rapidly as the chromate was depleted. Insoluble bismuth chromate appeared to enhance the effects of corrosion and performed worse than PVB samples that contained no pigment. Zinc and strontium species with intermediate aqueous solubility provided the greatest corrosion inhibition of the chromate pigments when used in the PVB wash primer.

Table 1 presents the accelerated corrosion testing results for bare 2024-T3 and 7075-T6 aluminum alloy test panels treated with PVB combined with zinc and strontium chromate corrosion inhibiting pigments. For each pigment, the first row shows the results on 2024-T3, and the second row shows the results on 7075-T6. The zinc and strontium chromate treated samples performed well during their period of exposure as is expected from the current state-of-the-art. Minor differences in performance as a function of substrate composition were noted.

TABLE 1
Zinc and Strontium Chromate Pigment Accelerated Corrosion Test Results

| | 2024-T3 B-117 | | 7075-T6 B-117 | | 2024-T3 G-85 | | 7075-T6 G-85 | |
|---|---|---|---|---|---|---|---|---|
| | 168 hrs | | 168 hrs | | 168 hrs | | 168 hrs | |
| Stabilizer | Proc. A | Proc. B | Proc. A | Proc. B | Proc. A | Proc. B | Proc. A | Proc. B |
| Zn as 1.35 g | 10 | 9 | 9 | 9 | 10 | 9 | 9 | 9 |
| zinc chromate | 10 | 9 | 9 | 9 | 10 | 9 | 9 | 9 |
| Sr as 1.51 g | 9 | 9 | 9 | 9 | 9 | 9 | 9 | 9 |
| strontium | 9 | 9 | 9 | 8 | 9 | 9 | 9 | 9 |
| chromate | | | | | | | | |

Evaluated by using ASTM D-1654 - Painted or Coated Specimens Subjected to Corrosive Environments.

5) Permanganate Pigments in PVB Resin

Sparingly soluble permanganate compounds were synthesized using either published literature procedures, or standard organometallic synthesis techniques because permanganate corrosion-inhibiting pigment materials are not commercially available. The pigment syntheses were aqueous-based precipitation techniques. The permanganate compounds formed included:

bismuth permanganate

cesium permanganate

lanthanum permanganate

cerium permanganate

tetra-n-butylammonium permanganate

tetra-n-propylammonium permanganate

Table 2 presents the accelerated corrosion testing results for bare 2024-T3 and 7075-T6 aluminum alloy test panels treated with permanganate pigments in PVB. The molar concentration of permanganate in these paints was half the molar concentration of chromate in the zinc and strontium chromate pigments shown in Table 1. This was done because the molecular weight of the permanganate compounds exceeds that of zinc or strontium chromate, implying that a larger mass would be necessary to achieve equal molar concentrations of MnVII and CrVI. As can be seen in the corrosion exposure results, even with these much lower molar concentrations of MnVII, the permanganate pigments provided substantial corrosion protection compared to chromium. These pigments also outperformed by a significant margin those pigments (i.e., molybdates, tungstates, phosphates, borates, cyanamides) containing no inherent oxidizer properties. For each pigment, the first row shows the performance of one sample under the specified conditions, and the second shows the performance of a duplicate sample under the same conditions.

TABLE 2
Permanganate Wash Primers Formulations

| Solubility | | 2024-T3 B-117 | | 7075-T6 B-117 | | 2024-T3 G-85 | | 7075-T6 G-85 | |
|---|---|---|---|---|---|---|---|---|---|
| Control | Inhibitor | 115 Hours | | 115 Hours | | 115 Hours | | 115 Hours | |
| Agent | Conc. (M) | Proc. A | Proc. B | Proc. A | Proc. B | Proc. A | Proc. B | Proc. A | Proc. B |
| Bi | 3.72 × 10⁻³ | 0 | 0 | 1 | 1 | 6 | 4 | 6 | 3 |
| | (5% of Cr) | 0 | 0 | 1 | 1 | 6 | 4 | 6 | 3 |
| Cs | 3.72 × 10⁻³ | 7 | 5 | 7 | 6 | 7 | 5 | 7 | 5 |
| | (5% of Cr) | 6 | 5 | 6 | 6 | 7 | 6 | 7 | 5 |
| La | 3.72 × 10⁻³ | 6 | 5 | 7 | 6 | 6 | 3 | 6 | 4 |
| | (5% of Cr) | 6 | 5 | 7 | 6 | 7 | 5 | 6 | 3 |
| Ce | 3.72 × 10⁻³ | 4 | 1 | 3 | 2 | 7 | 5 | 7 | 5 |
| | (5% of Cr) | 4 | 1 | 3 | 2 | 8 | 5 | 7 | 5 |
| NBu4 | 3.72 × 10⁻³ | 9 | 8 | 7 | 7 | 8 | 8 | 7 | 7 |
| | (5% of Cr) | 9 | 8 | 7 | 6 | 8 | 7 | 7 | 6 |
| NPr4 | 3.72 × 10⁻³ | 7 | 6 | 7 | 6 | 7 | 6 | 7 | 7 |
| | (5% of Cr) | 7 | 5 | 6 | 5 | 7 | 7 | 7 | 6 |

Evaluated by using ASTM D-1654 - Painted or Coated Specimens Subjected to Corrosive Environments.

6) Manganate Pigments

Attempts to incorporate manganate pigments (both hexavalent and pentavalent) into PVB primer systems were unsuccessful. The pigments were added satisfactorily to the base blend, but once the phosphoric acid diluent was added to the primer, the pigment rapidly decomposed. However, unreactive addition of these pigments to the base blend shows that other, more benign, polymer-based binder and resin systems might be applicable for use with these pigments.

While the invention has been described by reference to certain embodiments, it should be understood that numerous changes could be made within the spirit and scope of the inventive concepts described. Accordingly, it is intended that the invention not be limited to the disclosed embodiments, but that it have the full scope permitted by the language of the following claims.

We claim:

1. A corrosion-inhibiting pigment comprising manganese, wherein the manganese is heptavalent manganese, hexavalent manganese, pentavalent manganese, or combinations thereof, and a solubility control cation combined to form a permanganate compound or a manganate compound.

2. The pigment of claim 1 wherein the permanganate or manganate compound has a solubility in water of between about 1×10⁰ and about 1×10⁻⁵ moles per liter of manganese at about 25° C. and about 760 Torr.

3. The pigment of claim 2 wherein the permanganate or manganate compound has a solubility in water of between about 1×10⁻¹ and about 1×10⁻⁴ moles per liter of manganese at about 25° C. and about 760 Torr.

4. The pigment of claim 1 wherein there is an electrostatic barrier layer around the permanganate or manganate compound in aqueous solution.

5. The pigment of claim 1 wherein the permanganate or manganate compound decomposes above about 100° C.

6. The pigment of claim 1 wherein the permanganate or manganate compound melts above about 50° C.

7. The pigment of claim 1 wherein the solubility control cation is an inorganic solubility control cation or an organic solubility control cation.

8. The pigment of claim 7 wherein the solubility control cation for permanganates is the inorganic solubility control cation selected from Y⁺³, La⁺³, Ce⁺³, Pr⁺³, Nd⁺³, Cs⁺, Rb⁺, Ag⁺, K⁺, Li⁺, BiO⁺, SbO⁺, Tl⁺, Hg⁺, or combinations thereof.

9. The pigment of claim 8 wherein the solubility control cation for permanganates is the inorganic solubility control cation selected from Y⁺³, La⁺³, Ce⁺³, Pr⁺³, Nd⁺³, Cs⁺, Rb⁺, Ag⁺, BiO⁺, SbO⁺, or combinations thereof.

10. The pigment of claim 7 wherein the solubility control cation for permanganates is the organic solubility control cation selected from organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one seleonium site; organic compounds containing at least one iodonium site; quarternary ammonium compounds having a formula NR₄⁺, where R is an alkyl, aromatic, or acyclic organic constituent; or combinations thereof.

11. The pigment of claim 10 wherein the solubility control cation for permanganates is the organic solubility control cation selected from organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quarternary ammonium compounds having a formula NR₄⁺, where R is an alkyl, aromatic, or acyclic organic constituent; or combinations thereof.

12. The pigment of claim 7 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, Hg⁺, Cd⁺², Hg⁺², Ni⁺², Pb⁺², Tl⁺³, or combinations thereof.

13. The pigment of claim 12 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, or combinations thereof.

14. The pigment of claim 1 wherein the permanganate or manganate compound is adsorbed or mixed onto, into, or with an inert medium selected from oxides, hydroxides, phosphates, borates, silicates, carbonates, aluminates, titanates, molybdates, tungstates, oxalates, polymers, or combinations thereof.

15. The pigment of claim 1 wherein the solubility control cation is characterized by its ability to insolubilize a sulfur-based corrosion enhancing species.

16. The pigment of claim 15 wherein the sulfur-based corrosion enhancing species is selected from elemental sulfur, inorganic sulfides, organic sulfides, hydrogen sulfide, sulfites, bisulfites, sulfates, sulfur dioxide, sulfur trioxide, or combinations thereof.

17. A method of making a corrosion-inhibiting pigment comprising:
providing a solvent;
providing a manganese source in the solvent forming a manganese solution;
providing a solubility control cation; and
combining the manganese source and the solubility control cation to form a permanganate compound or a manganate compound.

18. The method of claim 17 wherein the manganese source is selected from divalent manganese sources, trivalent manganese sources, tetravalent manganese sources, pentavalent manganese sources, hexavalent manganese sources, heptavalent manganese sources, or combinations thereof.

19. The method of claim 17 further comprising oxidizing the manganese source.

20. The method of claim 19 wherein the manganese source is oxidized by adding an oxidizer to the manganese solution.

21. The method of claim 20 wherein the oxidizer is a dissolved solid, a liquid, or a gas.

22. The method of claim 20 wherein the oxidizer is selected from peroxides, superoxides, persulfates, perborates, pernitrates, perphosphates, percarbonates, persilicates, peraluminates, pertitanates, perzirconates, permolybdates, pertungstates, pervanadates, organic peroxyacid derivatives, ozone, hypochlorites, chlorates, perchlorates, hypobromites, chlorites, bormates, bismuthates, periodates, dissolved oxygen, dissolved chlorine, dissolved fluorine, or combinations thereof.

23. The method of claim 19 wherein the manganese source is oxidized by electrolysis.

24. The method of claim 17 wherein the permanganate or manganate compound is formed by a process selected from precipitation, evaporation, salting out with chemicals, freezing, freeze drying, or firing at an elevated temperature.

25. The method of claim 24 wherein the permanganate or manganate compound is formed by precipitation.

26. The method of claim 17 wherein the manganese source is manganese oxide, manganese dioxide, manganomanganic oxide, manganese sesquioxide, manganese hydroxide, manganese carbonate, manganese silicate, manganese borate, manganese sulfide, manganese phosphate, lithiated manganese spinel, manganese oxalate, manganese nitrate, manganese sulfate, manganese perchlorate, manganese chloride, manganese fluoride, manganese bromide, manganese iodide, manganese bromate, manganese chlorate, manganese fluosilicate, manganese fluotitanate, manganese fluozirconate, manganese fluoborate, manganese fluoaluminate, manganese formate, manganese acetate, manganese propionate, manganese butyrate, manganese valerate, manganese benzoate, manganese glycolate, manganese lactate, manganese tartronate, manganese malate, manganese tartrate, manganese citrate, manganese benzenesulfonate, manganese thiocyanate, manganese acetylacetonate, potassium permanganate, sodium permanganate, lithium permanganate, ammonium permanganate, magnesium permanganate, calcium permanganate, strontium permanganate, barium permanganate, zinc permanganate, ferric permanganate, nickel permanganate, copper permanganate, cobalt permanganate, cerium permanganate, lanthanum permanganate, yttrium permanganate, aluminum permanganate; cesium permanganate, rubidium permanganate, bismuth permanganate, or combinations thereof.

27. The method of claim 17 wherein the manganese source comprises a precipitate or a mineral.

28. The method of claim 27 wherein the manganese source comprises the mineral selected from manganosite, pyrochroite, rhodochrosite, rhodonite, tephroite, manganhumite, manganjustite, alabandite, hauerite, reddingite, hureaulite, pyrolusite, hausmannite, manganite, ramsdellite, bixbyite, groutite, feitknechite, akhtenskite, buserite, nsutite, hetaerolite, marokite, hydrohetaerolite, braunite, psilomelane, romanechite, cryptomelane, manjiroite, hollandite, birnesite, or combinations thereof.

29. The method of claim 17 wherein the solvent comprises water.

30. The method of claim 17 wherein the solubility control cation is an inorganic solubility control cation or an organic solubility control cation.

31. The method of claim 30 wherein the solubility control cation for permanganates is the inorganic solubility control cation selected from Y⁺³, La⁺³, Ce⁺³, Pr⁺³, Nd⁺³, Cs⁺, Rb⁺, Ag⁺, K⁺, Li⁺, BiO⁺, SbO⁺, Tl⁺, Hg⁺, or combinations thereof.

32. The method of claim 31 wherein the solubility control cation for permanganates is the inorganic solubility control cation selected from Y⁺³, La⁺³, Ce⁺³, Pr⁺³, Nd⁺³, Cs⁺, Rb⁺, Ag⁺, BiO⁺, SbO⁺, or combinations thereof.

33. The method of claim 30 wherein the solubility control cation for permanganates is the organic solubility control cation selected from organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one seleonium site; organic compounds containing at least one iodonium site; quarternary ammonium compounds having a formula NR₄⁺, where R is an alkyl, aromatic, or acyclic organic constituent; or combinations thereof.

34. The method of claim 33 wherein the solubility control cation for permanganates is the organic solubility control cation selected from organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quarternary ammonium compounds having a formula NR₄⁺, where R is an alkyl, aromatic, or acyclic organic constituent; or combinations thereof.

35. The method of claim 30 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, Hg⁺, Cd⁺², Hg⁺², Ni⁺², Pb⁺², Tl⁺³, or combinations thereof.

36. The method of claim 35 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, or combinations thereof.

37. The method of claim 17 wherein the solubility control cation is provided by adding the solubility control cation to the manganese solution.

38. The method of claim 17 wherein the solubility control cation is provided as a separate solution.

39. The method of claim 17 further comprising heating the manganese solution.

40. The method of claim 17 further comprising cooling the manganese solution.

41. The method of claim 17 further comprising adjusting the pH of the manganese solution using a compound selected from acids and bases.

42. The method of claim 17 further comprising adsorbing or mixing the permanganate or manganate compound onto, into, or with an inert medium selected from oxides, hydroxides, phosphates, borates, silicates, carbonates, aluminates, molybdates, tungstates, oxalates, polymers, or combinations thereof.

43. A method for treating a surface for corrosion resistance, comprising:
providing a substrate to be coated; and
applying a corrosion-inhibiting pigment comprising manganese, where the manganese is heptavalent manganese, hexavalent manganese, pentavalent manganese, or combinations thereof, and a solubility control cation combined to form a permanganate compound or a manganate compound.

44. The method of claim 43 wherein the substrate is subject to water-based electrochemical corrosion.

45. The method of claim 43 wherein the permanganate or manganate compound has a solubility in water of between about 1×10⁰ and about 1×10⁻⁵ moles per liter of manganese at about 25° C. and about 760 Torr.

46. The method of claim 45 wherein the permanganate or manganate compound has a solubility in water of between about 1×10⁻¹ and about 1×10⁻⁴ moles per liter of manganese at about 25° C. and about 760 Torr.

47. The method of claim 43 wherein there is an electrostatic barrier layer around the permanganate or manganate compound in aqueous solution.

48. The method of claim 43 werein the permanganate or manganate compound decomposes at a temperature above about 100° C.

49. The method of claim 43 wherein the permanganate or manganate compound melts at a temperature above about 50° C.

50. The method of claim 43 wherein the solubility control cation is an inorganic solubility control cation or an organic solubility control cation.

51. The method of claim 50 wherein the solubility control cation for permanganates is the inorganic solubility control cation selected from Y⁺³, La⁺³, Ce⁺³, Pr⁺³, Nd⁺³, Cs⁺, Rb⁺, Ag⁺, K⁺, Li⁺, BiO⁺, SbO⁺, Tl⁺, Hg⁺, or combinations thereof.

52. The method of claim 51 wherein the solubility control cation for permanganates is the inorganic solubility control cation selected from Y⁺³, La⁺³, Ce⁺³, Pr⁺³, Nd⁺³, Cs⁺, Rb⁺, Ag⁺, BiO⁺, SbO⁺, or combinations thereof.

53. The method of claim 50 wherein the solubility control cation for permanganates is the organic solubility control cation selected from organic compounds containing at least one N⁺ site; organic compounds containing at least one phosphonium site; organic compounds containing at least one arsonium site; organic compounds containing at least one stibonium site; organic compounds containing at least one oxonium site; organic compounds containing at least one sulfonium site; organic compounds containing at least one seleonium site; organic compounds containing at least one iodonium site; quarternary ammonium compounds having a formula NR₄⁺, where R is an alkyl, aromatic, or acyclic organic constituent; or combinations thereof.

54. The method of claim 53 wherein the solubility control cation for permanganates is the organic solubility control cation selected from organic compounds containing at least one N⁺ site; organic compounds containing at least one phosphonium site; organic compounds containing at least one stibonium site; organic compounds containing at least one oxonium site; organic compounds containing at least one sulfonium site; organic compounds containing at least one iodonium site; quarternary ammonium compounds having a formula NR₄⁺, where R is an alkyl, aromatic, or acyclic organic constituent; or combinations thereof.

55. The method of claim 50 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, Hg⁺, Cd⁺², Hg⁺², Ni⁺², Pb⁺², Tl⁺³, or combinations thereof.

56. The method of claim 55 wherein the solubility control cation for manganates is the inorganic solubility control cation selected from Rb⁺, Cs⁺, Ag⁺, Ba⁺², Sr⁺², Ca⁺², Zn⁺², Mg⁺², Co⁺², Bi⁺³, Al⁺³, In⁺³, or combinations thereof.

57. The method of claim 43 wherein the permanganate or manganate compound is adsorbed onto, into, or mixed with an inert medium selected from oxides, hydroxides, phosphates, borates, silicates, carbonates, aluminates, titanates, molybdates, tungstates, oxalates, polymers, or combinations thereof.

58. The method of claim 43 wherein the solubility control cation is characterized by its ability to insolubilize a sulfur-based corrosion enhancing species.

59. The method of claim 58 wherein the sulfur-based corrosion enhancing species is selected from elemental sulfur, inorganic sulfides, organic sulfides, hydrogen sulfide, sulfites, bisulfites, sulfates, sulfur dioxide, sulfur trioxide, or combinations thereof.

60. The method of claim 43 wherein the substrate is selected from metals, semimetals, semiconductors, composite materials with anisotropic electrical conductivity, materials in a conductive or dielectric medium, or combinations thereof.

61. The method of claim 43 further comprising surface treating the substrate before applying the pigment.

62. The method of claim 43 further comprising applying a coating to the substrate before applying the pigment.

63. The method of claim 43 further comprising applying a coating concurrently with applying the pigment.

64. The method of claim 43 further comprising applying a coating to the substrate, wherein the coating is selected from organic coatings, inorganic coatings, or combinations thereof.

65. The method of claim 64 wherein the coating is the organic coating selected from alkyd-type primers, acrylic primers, polyester primers, epoxy primers, conductive primers, organic sol-gels, ketimine coatings, polyvinyl coatings, acrylic thermoplastics, asphaltic and coal tar thermoplastics, polyamide thermoplastics, polyethylene dispersion thermoplastics, fluorocarbon thermoplastics, chlorocarbon thermoplastics, silicone thermosets, polyurethane thermosets, polyester thermosets, epoxy-amine thermosets, epoxy-amide thermosets, epoxy-ester thermosets, epoxy-coal tar thermosets, furane thermosets, phenolic thermosets, butadiene styrene elastomers, chlorinated rubber elastomers, polysulfonated elastomers, neoprene elastomers, sulfur-containing rubbers, or combinations thereof.

66. The method of claim 64 wherein the coating is the inorganic coating selected from low temperature enamels, low temperature glass frits, carbonaceous coatings, zeolites, inorganic sol-gels, or combinations thereof.

67. A corrosion-inhibiting pigment comprising manganese, wherein the manganese is heptavalent manganese, hexavalent manganese, pentavalent manganese, or combinations thereof, and a solubility control cation combined to form a permanganate compound or a manganate compound, wherein the permanganate or manganate compound is sparingly soluble in water at about 25° C. and about 760 Torr.

68. A method of making a corrosion-inhibiting pigment comprising:
providing a solvent;
providing a manganese source in the solvent forming a manganese solution;
providing a solubility control cation; and
combining the manganese source and the solubility control cation to form a permanganate compound or a manganate compound, wherein the permanganate or manganate compound is sparingly soluble in water at about 25° C. and about 760 Torr.

69. A method for treating a surface for corrosion resistance, comprising:
providing a substrate to be coated; and
applying a corrosion-inhibiting pigment comprising manganese, wherein the manganese is heptavalent manganese, hexavalent manganese, pentavalent manganese, or combinations thereof, and a solubility control cation combined to form a permanganate compound or a manganate compound, wherein the permanganate or manganate compound is sparingly soluble in water at about 25° C. and about 760 Torr.
